(19) United States
(12) Patent Application Publication
(10) Pub. No.: US 2018/0081186 A1
(43) Pub. Date: Mar. 22, 2018

(54) VIDEO VIEWER

(71) Applicant: Jen-Hua Hsu, Dongguan (CN)

(72) Inventor: Jen-Hua Hsu, Dongguan (CN)

(21) Appl. No.: 15/273,608

(22) Filed: Sep. 22, 2016

(51) Int. Cl. G02B 27/22; A45F 5/00

(52) U.S. Cl. CPC G02B 27/22; A45F 5/00

(57) ABSTRACT

a video viewer, comprising a main body, a chamber formed within the main body, two lenses detachably installed on one side of the main body, and a mounting part disposed on another side of the main body and being far away from the lenses, which is configured to removably install a video player; wherein the user watches an enlarged and virtual image through the lenses; the main body includes a slot disposed therein and arranged between the two lenses, and a partition plate removably installed into the slot. The lenses are detachable, which can be changed to the lenses having the parallel optical axes that are used to watch the 3D movie; which can also be changed to the lenses having the unparalleled optical axes with the partition board that are used to watch the 2D movie, so as to satisfy different use requirements.

### FIELD OF THE INVENTION

The present invention relates to a technical field of optical system, particularly to a video viewer.

### BACKGROUND OF THE INVENTION

Cell phone is widely used for chatting, reading novel, listening to the music, and watching movie. In particular, people often use the cell phone to watch movies, however, watching the movies on the cell phone cannot provide some truly stunning results that overwhelm our senses, it's not like people watch movie in a theater; besides, certain special visual effects cannot be watched on cell-phone screen, such as 3D movie.

Therefore, in order that people can enjoy better visual effects or 3D images for watching movies on the cell phone, the video viewer of the present invention is provided.

### SUMMARY OF INVENTION

The objective of the present invention is to overcome the shortcomings of the prior art and to provide a video viewer.

For solving the above mentioned problems, the technical scheme is adopted by a video viewer, comprising a main body configured to be worn on a user's head, a chamber formed within the main body, two lenses detachably installed on one side of the main body, and a mounting part disposed on another side of the main body and being far away from the lenses, which is configured to removably install a video player; wherein the user watches an enlarged and virtual image through the lenses; the main body includes a slot disposed therein and arranged between the two lenses, and a partition plate removably installed into the slot.

More particularly, wherein the two lenses comprise optical axes which are arranged parallel to each other.

More particularly, wherein the main body is configured with the partition plate disposed therein and arranged between the two lenses.

More particularly, wherein the two lenses comprise the optical axes which are arranged unparallel to each other, two lenses being inclined downwardly from adjacent sides thereof.

More particularly, wherein the main body comprises an arch-shaped supporting board disposed at one side of the lenses for providing support on human face, said supporting board being coupled to the main body by fasteners.

More particularly, wherein the main body comprises a housing and a cover pivotally connected to one side of the housing, the mounting part being disposed on the cover for the video player being installed inside the chamber, the cover being fixed to the housing by a clip.

More particularly, wherein the mounting part is a sticker pasted on an inner side of the cover; the video player is pasted on the sticker for fixing inside the main body.

More particularly, wherein the main body is formed with a concave part disposed at an end of the lens and correspondingly to human nose.

More particularly, wherein the main body is configured with a headband for the main body fixing on the user's head.

Compared to prior art, the present invention has the following advantages:

The video viewer can be used for watching movie disposed therein, the user can watch an enlarged and virtual image through the lenses, as if the user watches the movie in the theater.

The lenses are detachable, which can be changed to the lenses having the parallel optical axes that are used to watch the 3D movie; which can also be changed to the lenses having the unparalleled optical axes with the partition board that are used to watch the 2D movie, so as to satisfy different use requirements.

### BRIEF DESCRIPTION OF THE DRAWINGS

FIG. 1 is a schematic view of a first embodiment of the present invention;

FIG. 2 is an exploded view of the first embodiment of the present invention;

FIG. 3 is another exploded view of the first embodiment of the present invention;

FIG. 4 is a side elevation view of the first embodiment of the present invention;

FIG. 5 is a schematic view of a second embodiment of the present invention;

FIG. 6 is a side elevation view of the second embodiment of the present invention;

FIG. 7 is an exploded view of the second embodiment of the present invention;

### DETAILED DESCRIPTION OF THE PREFERRED EMBODIMENTS

The following embodiments with reference to the drawings of the present invention are further described.

A video viewer comprises a main body (1) configured to be worn on a user's head, the main body (1) being shaped like a three-dimensional trapezoid and composed of a housing and a cover pivotally connected to the housing, the cover which is capable of being opened and closed; a chamber (10) formed within the main body (1); two lenses (2) detachably installed on one side of the main body (1); and a mounting part (11) disposed on another side of the main body (1) and being far from the lenses (2), which is configured to removably install a video player (3); wherein the user watches an enlarged and virtual image through the lenses (2); the main body (1) includes a slot (15) disposed therein and arranged between the two lenses (2), and a partition plate (4) removably installed into the slot (15).

### A First Embodiment

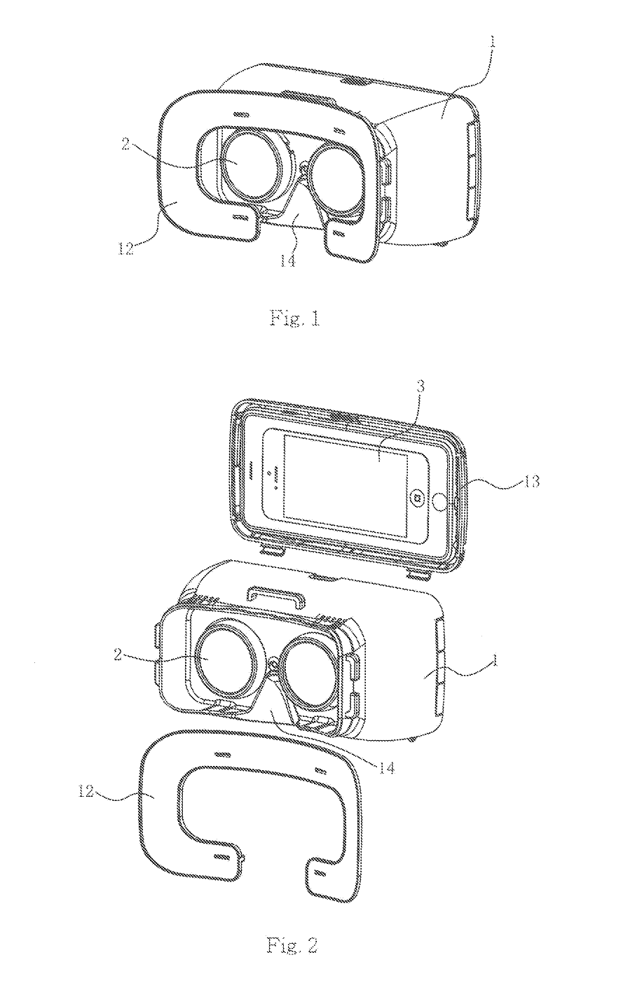

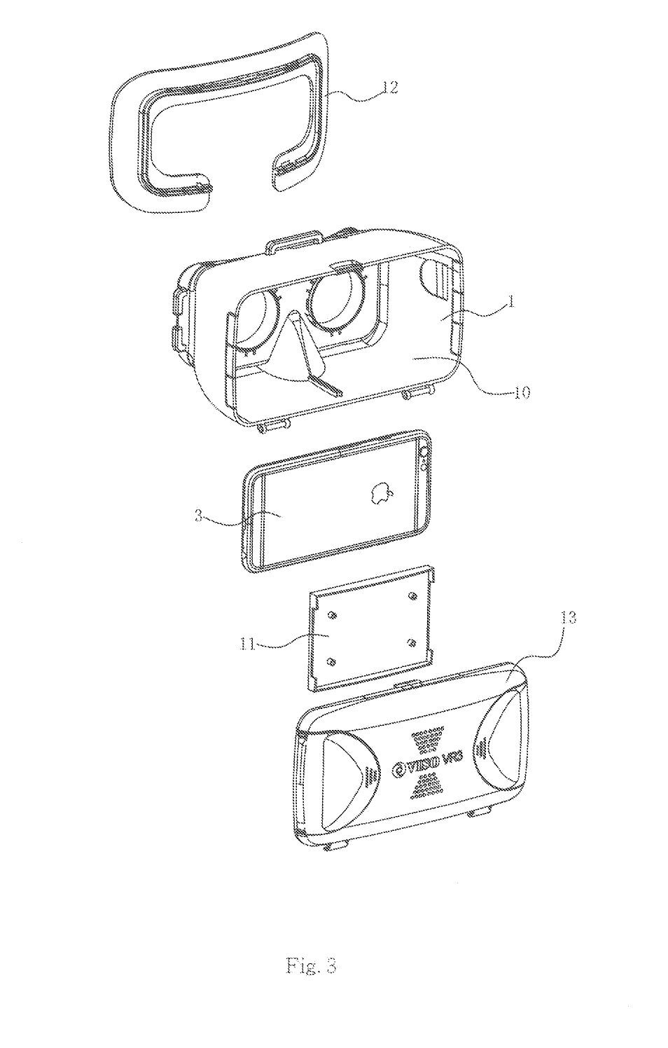

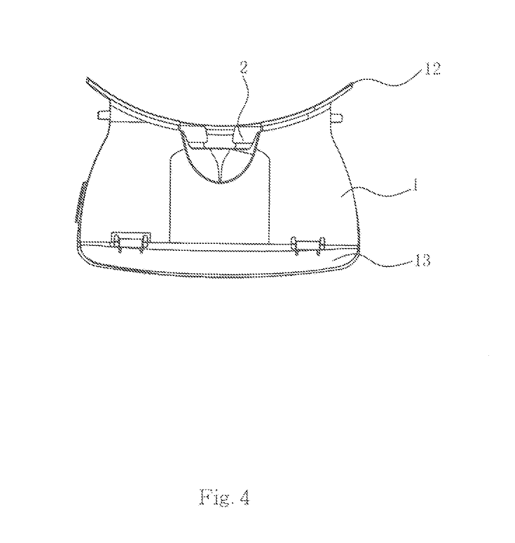

Referring to FIG. 1-4, the main body (1) comprises an arch-shaped supporting board (12) disposed at one side of the lenses (2) for providing support on human face; the supporting board (12) includes a cotton pad disposed along one side thereof to increase the wearing comfort. Said supporting board (12) is coupled to the main body (1) by fasteners. The main body (1) is formed with a concave part (14) disposed at an end of the lens (2) and correspondingly to human nose for more comfortable wearing.

The main body (1) having one side far away from the lens (2) is formed with a cover (13), said cover (13) having one side thereof pivotally connected to the main body (1) and the other side thereof including a fixing clip. The video player can be easily placed inside the main body (1) by opening the cover (13). The mounting part (11) is a sticker pasted on an inner side of the cover (13); the video player (3) is pasted on the sticker for fixing inside the main body (1). An organic silicone can be used as the sticker that does not leave stains of adherent thereon when the sticker is removed from the cover (13). The main body (1) is configured with a headband for the main body (1) stably fixing on the user's head.

The two lenses (2) comprise optical axes which are arranged parallel to each other. The two lenses (2) are mounted on the main body (1) through mounting sleeves, the main body (1) includes two holes disposed at one side thereof and configured for the mounting sleeves installed thereinto, and the two lenses (2) are mounted on the holes and arranged on the same horizontal plane. The lenses (2) mounted on the holes can be used with either an insertion manner or a threaded connection. At this point, it is required to use a partition plate (4) to watch 3D movie. When using the video view, the user should open the cover (13), put the video player (3) on the sticker, enter a play button on the video player (3), close the cover (13), and then wear the video viewer on the user's head by the headband, whereby the user can watch the movie through the lenses which can produce clear enlarged and virtual image, and improve visual effect. The above-mentioned video player (3) is a cell phone in the first embodiment.

### A Second Embodiment

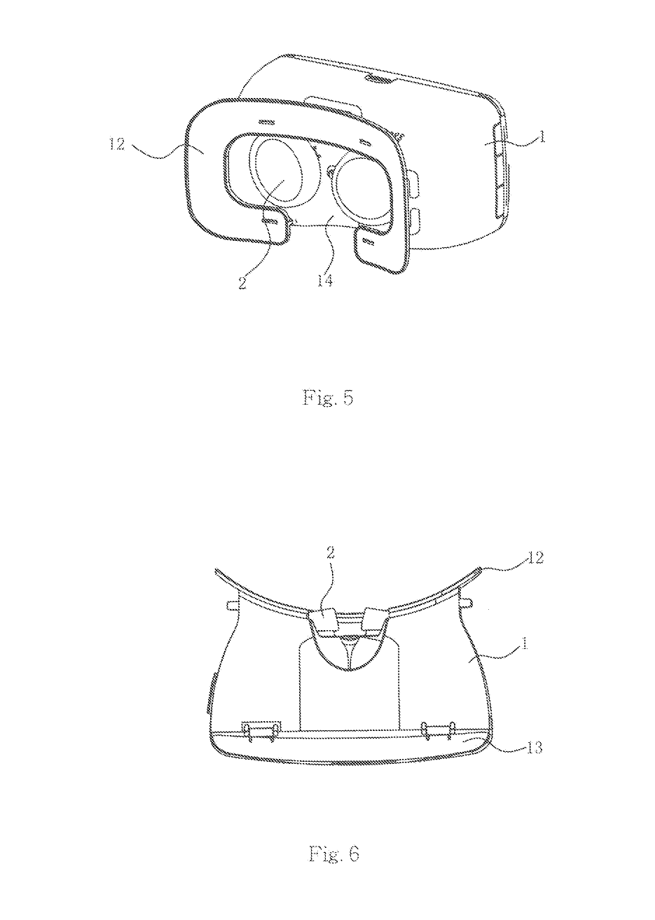

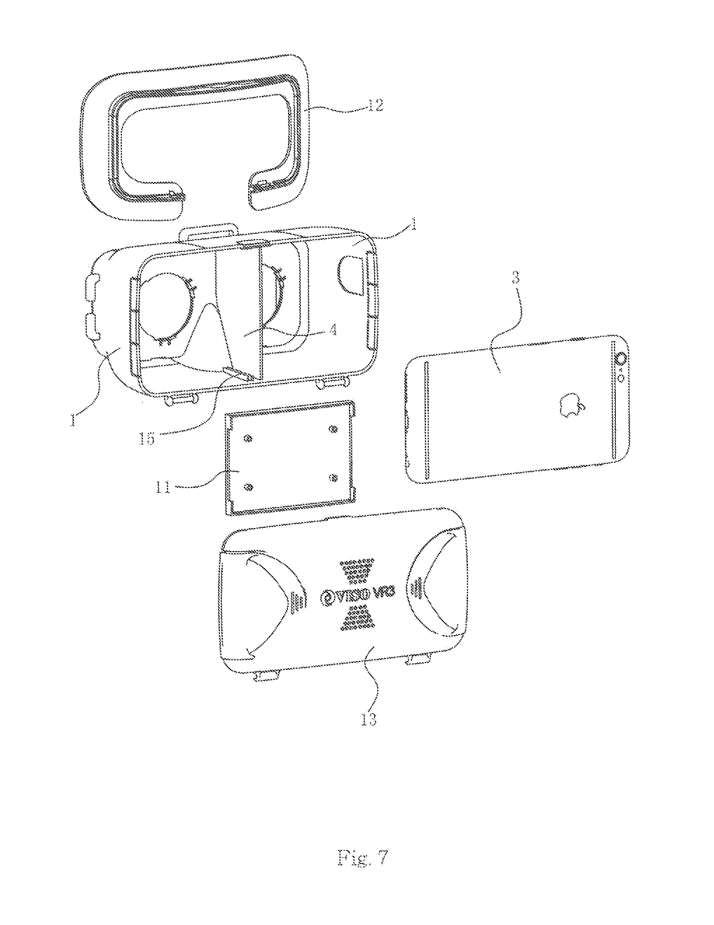

Referring to FIGS. 5-7, the main body (1) comprises an arch-shaped supporting board (12) disposed at one side of the lenses (2) for providing support on human face; the supporting board (12) includes a cotton pad disposed along one side thereof to increase the wearing comfort. Said supporting board (12) is coupled to the main body (1) by fasteners. The main body (1) is formed with a concave part (14) disposed at an end of the lens (2) and correspondingly to human nose for more comfortable wearing.

The main body (1) having one side far away from the lens (2) is formed with a cover (13), said cover (13) having one side thereof pivotally connected to the main body (1) and the other side thereof including a fixing clip. The video player can be easily placed inside the main body (1) by opening the cover (13). The mounting part (11) is a sticker pasted on an inner side of the cover (13); the video player (3) is pasted on the sticker for fixing inside the main body (1). An organic silicone can be used as the sticker that does not leave stains of adherent thereon when the sticker is removed from the cover (13). The main body (1) is configured with a headband for the main body (1) stably fixing on the user's head.

The two lenses (2) comprises the optical axes which are arranged unparallel to each other, the two lenses (2) are mounted on the main body (1) through the two mounting sleeves, the main body (1) includes two holes disposed at one side thereof and configured for the mounting sleeves installed thereinto, the two mounting sleeves are inclined downwardly from adjacent sides thereof, the two lenses (2) are mounted on the two mounting sleeves, and two lenses (2) are also inclined downwardly from adjacent sides thereof.

At this point, it is not required to install the partition plate (4) to watch 2D movie, so that long and enlarged video is provided by the two lenses. When using the video view, the user should open the cover (13), put the video player (3) on the sticker, enter a play button on the video player (3), close the cover (13), and then wear the video viewer on the user's head by the headband, whereby the user can watch the movie through the lenses which can produce clear enlarged and virtual image, and improve visual effect. The above-mentioned video player (3) is a cell phone in the second embodiment.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A video viewer, comprising:
a main body (1) configured to be worn on a user's head, a chamber (10) formed within the main body (1), two lenses (2) detachably installed on one side of the main body (1), and a mounting part (11) disposed on another side of the main body (1) and being far away from the lenses (2), which is configured to removably install a video player (3); wherein the user watches an enlarged and virtual image through the lenses (2); the main body (1) includes a slot (15) disposed therein and arranged between the two lenses (2), and a partition plate (4) removably installed into the slot (15).

2. The video viewer according to claim 1, wherein the two lenses (2) comprise optical axes which are arranged parallel to each other.

3. The video viewer according to claim 1, wherein the partition plate (4) is disposed inside the main body (1) and arranged between the two lenses (2).

4. The video viewer according to claim 1, wherein the two lenses (2) comprise optical axes which are arranged unparallel to each other, two lenses being inclined downwardly from adjacent sides thereof.

5. The video viewer according to claim 1, wherein the main body (1) comprises an arch-shaped supporting board (12) disposed at one side of the lenses (2) for providing support on human face, said supporting board (12) being coupled to the main body (1) by fasteners.

6. The video viewer according to claim 1, wherein the main body (1) comprises a housing and a cover (13) pivotally connected to one side of the housing, the mounting part (11) being disposed on the cover (13) for the video player being installed inside the chamber (10), the cover (13) being fixed to the housing by a clip.

7. The video viewer according to claim 6, wherein the mounting part (11) is a sticker pasted on an inner side of the cover (13); the video player (3) is pasted on the sticker for fixing inside the main body (1).

8. The video viewer according to claim 1, wherein the main body (1) is formed with a concave part (14) disposed at an end of the lens and correspondingly to human nose.

9. The video viewer according to claim 1, wherein the main body (1) is configured with a headband for the main body (1) fixing on the user's head.
